(19) United States
(12) Patent Application Publication
(10) Pub. No.: US 2022/0002505 A1
(43) Pub. Date: Jan. 6, 2022

(54) CURABLE COMPOSITION OF ELASTOMERS

(71) Applicant: SOLVAY SPECIALTY POLYMERS ITALY S.P.A., Bollate (IT)

(72) Inventors: Floryan DE CAMPO, Ixelles (BE); Matteo FANTONI, Vanzaghello (IT)

(21) Appl. No.: 17/283,325

(22) PCT Filed: Oct. 25, 2019
(86) PCT No.: PCT/EP2019/079303

§ 371 Date: Apr. 7, 2021

(30) Foreign Application Priority Data
Oct. 31, 2018 (EP) 18306433.6

(51) Int. Cl. C08J 3/24; C08L 27/12

(52) U.S. Cl. CPC C08J 3/241; C08L 27/12; C08L 2207/53; C08L 2205/14; C08J 2327/12

(57) ABSTRACT

The invention pertains to compositions comprising an elastomer and a plurality of microcapsules having a cross-linked polymeric shell and a core containing at least one (per)fuoropolyether compound comprising a (per)fluoropolyoxyalkylene chain being a sequence of recurring units having at least one catenary ether bond and at least one fluorocarbon moiety.

### CROSS REFERENCE TO RELATED APPLICATIONS

This application claims priority to European patent application No.

18306433.6 filed on Oct. 31, 2018, the whole content of this application being incorporated herein by reference for all purposes.

### TECHNICAL FIELD

The invention pertains to a curable composition of elastomers having a reduced coefficient of friction and to a process for its manufacture.

### BACKGROUND ART

Elastomers, in particular (per)fluoroelastomers, are materials with excellent heat-resistance and chemical-resistance characteristics, which are generally used in the manufacture of sealing articles such as oil seals, gaskets, shaft seals and O-rings, wherein the leak-tightness, the mechanical properties and the resistance to substances such as mineral oils, hydraulic fluids, solvents or chemical agents of diverse nature must be ensured over a wide range of working temperatures.

The frictional behaviour of elastomers sliding against hard counterfaces is of a great interest in sealing application. A low friction coefficient is desirable because provides longer duration of elastomeric products and the application of less energy in the running phase.

Several attempts have already been made for addressing the challenge of reducing the friction coefficient of elastomers.

A common approach involved the addition of low friction fillers to elastomers. Examples of such fillers are PTFE, PFPE, molybdenum disulphide or graphite.

For instance, U.S. Pat. No. 6,005,054 describes a method of improving the friction coefficient of fluoroelastomeric compositions consisting of incorporating mono- and/or di-hydroxypolyfluoroethers as additives in ionic or radical curing compositions of fluoroelastomers.

Still, EP 222 408 describes introducing mono- and/or di-hydroxypolyfluoroethers in vulcanizable compositions of fluoroelastomers based on vinylidene fluoride.

Yet in this domain, U.S. Pat. No. 4,278,776 describes mixing perfluoropolyamide and a mixture consisting of perfluoropolyethers and polytetrafluoroethylene with a fluoroelastomer.

However, need is still felt to provide elastomeric compositions having lower friction coefficients.

### SUMMARY OF INVENTION

The aim of the present invention is to provide a curable composition of elastomers with improved friction coefficient, which maintains during the time, while keeping good mechanical and elastic properties.

In a first aspect, the present invention relates to a composition comprising at least one elastomer [elastomer (A)] and a plurality of microcapsules [capsules (M)], said capsules (M) having a cross-linked polymeric shell and a core containing at least one (per)fuoropolyether compound [compound (PFPE)] comprising a (per)fluoropolyoxyalkylene chain [chain (R_{f})], said chain (R_{f}) being a sequence of recurring units having at least one catenary ether bond and at least one fluorocarbon moiety.

In a second aspect, the present invention relates to a process for preparing the composition (C) as defined above, said method comprising mixing said at least one elastomer (A) with said plurality of capsules (M), as detailed above.

In a third aspect, the present invention relates to a method for fabricating shaped articles comprising curing the above defined composition (C).

In a forth aspect, the present invention relates to a shaped article obtained with the above identified method, said shaped article being selected from the group consisting of sealing articles, including O(square)-rings, packings, gaskets, diaphragms, shaft seals, valve stem seals, piston rings, crankshaft seals, cam shaft seals, and oil seals, in particular flexible hoses or other items, including conduits for delivery of hydrocarbon fluids and fuels.

### DETAILED DESCRIPTION OF THE INVENTION

For the purposes of this invention, the term “elastomer” is intended to designate a polymer resin serving as a base constituent for obtaining a true elastomer.

True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

The term “(per)fluoroelastomer” is intended to indicate a fully or partially fluorinated elastomer, in particular comprising more than 10% (wt), preferably more than 30% (wt), of recurring units derived from at least one ethylenically unsaturated monomer comprising at least one fluorine atom (hereafter, (per)fluorinated monomer) and, optionally, recurring units derived from at least one ethylenically unsaturated monomer free from fluorine atom (hereafter, hydrogenated monomer).

The expression “polyunsaturated compound” is intended to designate a compound comprising more than one carbon-carbon unsaturation.

Any amount expressed in “phr” is based on 100 weight parts of the elastomer.

In the present description, the use of parentheses “( . . . )” before and after the names of compounds, symbols or numbers identifying formulae or parts of formulae like, for example, “composition (C)” and elastomer (A)”, has the mere purpose of better distinguishing those names, symbols or numbers from the remaining text; thus, said parentheses could also be omitted.

Preferably, the amount of the capsules (M) ranges from 0.1 to 50 phr, preferably from 2 to 10 phr, more preferably from 3 to 5 phr, based on 100 weight parts of the elastomer (A).

Elastomer (A)

The elastomer (A) may be selected from saturated and unsaturated rubbers. Among the unsaturated rubbers, the elastomer (A) may be selected from: acrylonitrile/butadiene rubber (NBR), hydrogenated acrylonitrile/butadiene rubber (HNBR), styrene/butadiene rubber (SBR), polyisoprene, polybutadiene (BR), polychloroprene (CR), isobutylene/isoprene rubber (IIR), polyurethane (PU). Among the saturated rubbers, the elastomer (A) may be selected from: ethylene propylene rubber (EPM), silicones, fluorosilicone, polyacrylic rubber (ACM), epichlorohydrin (ECO), chlorosulfonated polyethylene (CSM), chloropolyethylene (CM), polyether block amides (PEBA), ethylene-vinyl acetate (EVA), (per)fluoroelastomers. The elastomer (A) may also be selected from thermoplastic elastomers (TPE), thermoplastic vulcanizates (TPV) and thermoplastic polyurethanes (TPU).

According to a preferred embodiment, the elastomer (A) is a (per)fluoroelastomer. As defined above, a (per)fluoroelastomer comprises recurring units derived from at least one (per)fluorinated monomer. Preferably, said (per)fluorinated monomer is selected from the group consisting of:
C₂-C₈ fluoro- and/or perfluoroolefins, such as tetrafluoroethylene (TFE), hexafluoropropene (HFP), pentafluoropropylene, and hexafluoroisobutylene;
C₂-C₈ hydrogenated monofluoroolefins, such as vinyl fluoride;
1,2-difluoroethylene, vinylidene fluoride (VDF) and trifluoroethylene (TrFE);
(per)fluoroalkylethylenes complying with formula CH₂═CH—R_{f0}, in which R_{f0} is a C₁-C₆ (per)fluoroalkyl or a C₁-C₆ (per)fluorooxyalkyl having one or more ether groups;
chloro- and/or bromo- and/or iodo-C₂-C₆ fluoroolefins, like chlorotrifluoroethylene (CTFE);
fluoroalkylvinylethers complying with formula CF₂═CFOR_{f1} in which R_{f1} is a C₁-C₆ fluoro- or perfluoroalkyl, e.g. —CF₃, —C₂F₅, —C₃F₇;
hydrofluoroalkylvinylethers complying with formula CH₂═CFOR_{f1} in which R_{f1} is a C₁-C₆ fluoro- or perfluoroalkyl, e.g. —CF₃, —C₂F₅, —C₃F₇;
fluoro-oxyalkylvinylethers complying with formula CF₂═CFOX₀, in which X₀ is a C₁-C₁₂ oxyalkyl, or a C₁-C₁₂ (per)fluorooxyalkyl having one or more ether groups; in particular (per)fluoro-methoxy-vinylethers complying with formula CF₂═CFOCF₂OR_{f2} in which R_{f2} is a C₁-C₆ fluoro- or perfluoroalkyl, e.g. —CF₃, —C₂F₅, —C₃F₇ or a C₁-C₆ (per)fluorooxyalkyl having one or more ether groups, like —C₂F₅—O—CF₃;
functional fluoro-alkylvinylethers complying with formula CF₂═CFOY₀, in which Y₀ is a C₁-C₁₂ alkyl or (per)fluoroalkyl, or a C₁-C₁₂ oxyalkyl or a C₁-C₁₂ (per)fluorooxyalkyl, said Y₀ group comprising a carboxylic or sulfonic acid group, in its acid, acid halide or salt form;
(per)fluorodioxoles, of formula:

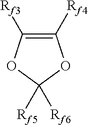

wherein each of R_{f3}, R_{f4}, R_{f5}, R_{f6}, equal to or different from each other, is independently a fluorine atom, a C₁-C₆ fluoro- or per(halo)fluoroalkyl, optionally comprising one or more oxygen atom, e.g. —CF₃, —C₂F₅, —C₃F₇, —OCF₃, —OCF₂CF₂OCF₃.

The (per)fluoroelastomer may also comprise recurring units derived from at least one hydrogenated monomer. Examples of hydrogenated monomers are notably hydrogenated alpha-olefins, including ethylene, propylene, 1-butene, diene monomers, styrene monomers, alpha-olefins being typically used.

The (per)fluoroelastomer is in general an amorphous product or a product having a low degree of crystallinity (crystalline phase less than 20% by volume) and a glass transition temperature (T_{g}) below room temperature. In most cases, the (per)fluoroelastomer advantageously has a T_{g} below 10° C., preferably below 5° C., more preferably 0° C.

Preferably, the (per)fluoroelastomer is selected among:

(1) VDF-based copolymers, in which VDF is copolymerized with at least one additional comonomer selected from the group consisting of:
(a) C₂-C₈ perfluoroolefins, such as tetrafluoroethylene (TFE), hexafluoropropylene (HFP);
(b) hydrogen-containing C₂-C₈ olefins, such as vinyl fluoride (VF), trifluoroethylene (TrFE), hexafluoroisobutene (HFIB), perfluoroalkyl ethylenes of formula CH₂═CH—R_{f}, wherein R_{f} is a C₁-C₆ perfluoroalkyl group;
(c) C₂-C₈ fluoroolefins comprising at least one of iodine, chlorine and bromine, such as chlorotrifluoroethylene (CTFE);
(d) (per)fluoroalkylvinylethers (PAVE) of formula CF₂═CFOR_{f}, wherein R_{f} is a C₁-C₆ (per)fluoroalkyl group, preferably CF₃, C₂F₅, C₃F₇;
(e) (per)fluoro-oxy-alkylvinylethers of formula CF₂═CFOX, wherein X is a C₁-C₁₂ ((per)fluoro)-oxyalkyl comprising catenary oxygen atoms, e.g. the perfluoro-2-propoxypropyl group;
(f) (per)fluorodioxoles having formula:

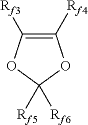

wherein each of R_{f3}, R_{f4}, R_{f5}, R_{f6}, equal to or different from each other, is independently selected from the group consisting of fluorine atom and C₁-C₆ (per)fluoroalkyl groups, optionally comprising one or more than one oxygen atom, such as notably —CF₃, —C₂F₅, —C₃F₇, —OCF₃, —OCF₂CF₂OCF₃; preferably, perfluorodioxoles;
(g) (per)fluoro-methoxy-vinylethers (MOVE, hereinafter) having formula:

CF₂═CFOCF₂OR_{f2}

wherein R_{f2} is selected from the group consisting of C₁-C₆ (per)fluoroalkyls; C₅-C₆ cyclic (per)fluoroalkyls; and C₂-C₆ (per)fluorooxyalkyls, comprising at least one catenary oxygen atom; R_{f2} is preferably —CF₂CF₃ (MOVE1); —CF₂CF₂OCF₃ (MOVE2); or —CF₃ (MOVE3);
(h) C₂-C₈ non-fluorinated olefins (OI), for example ethylene and propylene;
(i) ethylenically unsaturated compounds comprising nitrile (—CN) groups, possibly (per)fluorinated; and
(2) TFE-based copolymers, in which TFE is copolymerized with at least one additional comonomer selected from the group consisting of (c), (d), (e), (g), (h) and (i) as above detailed.

Optionally, the (per)fluoroelastomer of the present invention comprises recurring units derived from a bis-olefin [bis-olefin (OF)] having general formula:

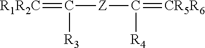

wherein R₁, R₂, R₃, R₄, R₅ and R₆, equal or different from each other, are H or C₁-C₅ alkyl; Z is a linear or branched C₁-C₁₈ (hydro)carbon radical (including alkylene or cycloalkylene radical), optionally containing oxygen atoms, preferably at least partially fluorinated, or a (per)fluoro(poly)oxyalkylene radical comprising one or more catenary ethereal bonds.

The bis-olefin (OF) is preferably selected from the group consisting of those complying with formulae (OF-1), (OF-2) and (OF-3):

### (OF-1)

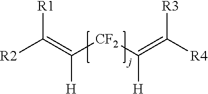

wherein j is an integer between 2 and 10, preferably between 4 and 8, and R1, R2, R3, R4, equal or different from each other, are H, F or C₁₋₅ alkyl or (per)fluoroalkyl group;

### (OF-2)

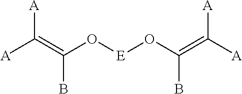

wherein each of A, equal or different from each other and at each occurrence, is independently selected from F, Cl, and H; each of B, equal or different from each other and at each occurrence, is independently selected from F, Cl, H and ORB, wherein RB is a branched or straight chain alkyl radical which can be partially, substantially or completely fluorinated or chlorinated; E is a divalent group having 2 to 10 carbon atom, optionally fluorinated, which may be inserted with ether linkages; preferably E is a —(CF₂)ₘ— group, with m being an integer from 3 to 5; a preferred bis-olefin of (OF-2) type is F₂C═CF—O—(CF₂)₅—O—CF═CF₂.

### (OF-3)

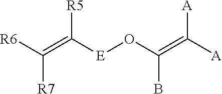

wherein E, A and B have the same meaning as above defined; R5, R6, R7, equal or different from each other, are H, F or Cis alkyl or (per)fluoroalkyl group.

Among specific compositions of (per)fluoroelastomers suitable for the purpose of the invention, mention can be made of (per)fluoroelastomers having the following compositions (in mol %):

(i) vinylidene fluoride (VDF) 35-85%, hexafluoropropene (HFP) 10-45%, tetrafluoroethylene (TFE) 0-30%, perfluoroalkyl vinyl ethers (PAVE) 0-15%, bis-olefin (OF) 0-5%;
(ii) vinylidene fluoride (VDF) 50-80%, perfluoroalkyl vinyl ethers (PAVE) 5-50%, tetrafluoroethylene (TFE) 0-20%, bis-olefin (OF) 0-5%;
(iii) vinylidene fluoride (VDF) 20-30%, C₂-C₈ non-fluorinated olefins (01) 10-30%, hexafluoropropene (HFP) and/or perfluoroalkyl vinyl ethers (PAVE) 18-27%, tetrafluoroethylene (TFE) 10-30%, bis-olefin (OF) 0-5%;
(iv) tetrafluoroethylene (TFE) 50-80%, perfluoroalkyl vinyl ethers (PAVE) 20-50%, bis-olefin (OF) 0-5%;
(v) tetrafluoroethylene (TFE) 45-65%, C₂-C₈ non-fluorinated olefins (01) 20-55%, vinylidene fluoride 0-30%, bis-olefin (OF) 0-5%;
(vi) tetrafluoroethylene (TFE) 32-60%, C₂-C₈ non-fluorinated olefins (01) 10-40%, perfluoroalkyl vinyl ethers (PAVE) 20-40%, fluorovinyl ethers (MOVE) 0-30%, bis-olefin (OF) 0-5%;
(vii) tetrafluoroethylene (TFE) 33-75%, perfluoroalkyl vinyl ethers (PAVE) 15-45%, vinylidene fluoride (VDF) 5-30%, hexafluoropropene HFP 0-30%, bis-olefin (OF) 0-5%;
(viii) vinylidene fluoride (VDF) 35-85%, fluorovinyl ethers (MOVE) 5-40%, perfluoroalkyl vinyl ethers (PAVE) 0-30%, tetrafluoroethylene (TFE) 0-40%, hexafluoropropene (HFP) 0-30%, bis-olefin (OF) 0-5%;
(ix) tetrafluoroethylene (TFE) 20-70%, fluorovinyl ethers (MOVE) 30-80%, perfluoroalkyl vinyl ethers (PAVE) 0-50%, bis-olefin (OF) 0-5%.

(Per)fluoroelastomers suitable for the purpose of the invention can be prepared by any known method, such as emulsion or micro-emulsion polymerization, suspension or micro-suspension polymerization, bulk polymerization and solution polymerization.

The (per)fluoroelastomer advantageously comprises cure sites; the selection of cure sites is not particularly critical, provided that they ensure adequate reactivity in curing.

Preferably, the (per)fluoroelastomer of the invention comprises at least one of chlorine, iodine and bromine cure-sites in an amount such that their content ranges between 0.001 and 10% (wt), with respect to the total weight of the (per)fluoroelastomer. Iodine and bromine cure-sites are preferred because they maximize the curing rate. For ensuring acceptable reactivity, the content of iodine and/or bromine in the (per)fluoroelastomer should be of at least 0.05% (wt), preferably of at least 0.1% (wt), more preferably of at least 0.15% (wt), with respect to the total weight of the (per)fluoroelastomer. On the other side, amounts of iodine and/or bromine not exceeding preferably 7% (wt), more specifically not exceeding 5% (wt), or even not exceeding 4% (wt), with respect to the total weight of the (per)fluoroelastomer, are generally selected for avoiding side reactions and/or detrimental effects on thermal stability.

According to a first embodiment, the cure-sites are comprised as terminal groups of the backbone of the (per)fluoroelastomer chain and the (per)fluoroelastomer is preferably obtained by adding to the polymerization medium any of:
iodinated and/or brominated chain-transfer agent(s); suitable chain-chain transfer agents are typically those of formula R_{f}(I)ₓ(Br)_{y}, in which R_{f} is a (per)fluoroalkyl or a (per)fluorochloroalkyl containing from 1 to 8 carbon atoms, while x and y are integers between 0 and 2, with 1≤x+y≤2 (see, for example, U.S. Pat. No. 4,243,770 (DAIKIN IND LTD) 6 Jan. 1981 and U.S. Pat. No. 4,943,622 (NIPPON MEKTRON KK) 24 Jul. 1990); and
alkali metal or alkaline-earth metal iodides and/or bromides, such as described notably in U.S. Pat. No. 5,173,553 (AUSIMONT SRL) 22 Dec. 1992.

According to a second embodiment, said cure-sites are comprised as pending groups bound to the backbone of the (per)fluoroelastomer chain by means of incorporation in the (per)fluoroelastomer chain of recurring units derived from the following monomers:
halogen-containing monomers of formula (CSM-1):

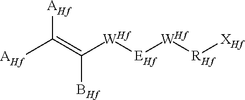

wherein each of A_{Hf}, equal to or different from each other and at each occurrence, is independently selected from F, Cl, and H; B_{Hf} is any of F, Cl, H and OR^{Hf}_{B}, wherein R^{Hf}_{B} is a branched or straight chain alkyl radical which can be partially, substantially or completely fluorinated or chlorinated; each of W^{Hf} equal to or different from each other and at each occurrence, is independently a covalent bond or an oxygen atom; E_{Hf} is a divalent group having 2 to 10 carbon atom, optionally fluorinated; R_{Hf} is a branched or straight chain alkyl radical, which can be partially, substantially or completely fluorinated, which may be inserted with ether linkages; preferably E is a —(CF₂)ₘ— group, with m being an integer from 3 to 5; and X_{Hf} is a halogen atom selected from the group consisting of chlorine, iodine and bromine, preferably selected from the group consisting of iodine and bromine;
ethylenically unsaturated compounds comprising cyanide groups, possibly fluorinated (CSM-2).

Preferred monomers of type (CSM1) are the following:

### (CSM1-A):

iodine-containing perfluorovinylethers of formula:

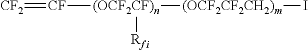

with m being an integer from 0 to 5 and n being an integer from 0 to 3, with the proviso that at least one of m and n is different from 0, and R_{fi} being F or CF₃; (as notably described in U.S. Pat. No. 4,745,165 (AUSIMONT SPA) 17 May 1988, U.S. Pat. No. 4,564,662 (MINNESOTA MINING) 14 Jan. 1986 and EP 199138 A (DAIKIN IND LTD) 29 Oct. 1986); and

### (CSM-1B):

iodine-containing ethylenically unsaturated compounds of formula:

CX¹X²═CX³—(CF₂CF₂)ₚ—I

wherein each of X¹, X² and X³, equal to or different from each other, are independently H or F; and p is an integer from 1 to 5; among these compounds, mention can be made of CH₂═CHCF₂CF₂I, I(CF₂CF₂)₂CH═CH₂, ICF₂CF₂CF═CH₂, I(CF₂CF₂)₂CF═CH₂;

### (CSM-1C):

iodine-containing ethylenically unsaturated compounds of formula:

CHR═CH—Z—CH₂CHR—I

wherein R is H or CH₃, Z is a C₁-C₁₈ (per)fluoroalkylene radical, linear or branched, optionally containing one or more ether oxygen atoms, or a (per)fluoropolyoxyalkylene radical; among these compounds, mention can be made of CH₂═CH—(CF₂)₄CH₂CH₂I, CH₂═CH—(CF₂)₆CH₂CH₂I, CH₂═CH—(CF₂)₈CH₂CH₂I, CH₂═CH—(CF₂)₂CH₂CH₂I;

### (CSM-1D):

bromo and/or iodo alpha-olefins containing from 2 to 10 carbon atoms such as bromotrifluoroethylene or bromotetrafluorobutene described, for example, in U.S. Pat. No. 4,035,565 (DU PONT) 12 Jul. 1977 or other compounds bromo and/or iodo alpha-olefins disclosed in U.S. Pat. No. 4,694,045 (DU PONT) 15 Sep. 1987.

Preferred monomers of type (CSM2) are the following:

### (CSM2-A):

perfluorovinyl ethers containing cyanide groups of formula CF₂═CF—(OCF₂CFX^{CN})ₘ—O—(CF₂)ₙ—CN, with X^{CN} being F or CF₃, m being 0, 1, 2, 3 or 4; n being an integer from 1 to 12;

### (CSM2-B):

perfluorovinyl ethers containing cyanide groups of formula CF₂═CF—(OCF₂CFX^{CN})_{m′}—O—CF₂—CF(CF₃)—CN, with X^{CN} being F or CF₃, m′ being 0, 1, 2, 3 or 4.
Specific examples of cure-site containing monomers of type CSM2-A and CSM2-B suitable to the purposes of the present invention are notably those described in U.S. Pat. No. 4,281,092 (DU PONT) 28 Jul. 1981, U.S. Pat. No. 4,281,092 (DU PONT) 28 Jul. 1981, U.S. Pat. No. 5,447,993 (DU PONT) 5 Sep. 1995 and U.S. Pat. No. 5,789,489 (DU PONT) 4 Aug. 1998.

The (per)fluoroelastomer according to said second embodiment generally comprises recurring units derived from iodine- or bromine-containing monomers (CSM-1) in amounts of 0.05 to 5 mol per 100 mol of all other recurring units of the (per)fluoroelastomer, so as to advantageously ensure the above mentioned iodine and/or bromine weight content.

Compound (PFPE)

As said, the composition (C) may comprise one or more than one compounds (PFPE).

As said, the compound (PFPE) comprises a (per)fluoropolyoxyalkylene chain [chain (R_{f})] being a sequence of recurring units having at least one catenary ether bond and at least one fluorocarbon moiety.

The nature of end groups in compound (PFPE) is not particularly limited; it is generally understood that functional groups comprising heteroatoms different from halogens may be present in (per)fluorocarbon end groups; such functional groups may include notably hydroxyl groups, acyl halide groups, carboxylic acid groups, ester groups, amide groups, ethylenically unsaturated groups, acrylic groups, (hetero)aromatic groups, and the like.

It is nonetheless understood that according to certain preferred embodiments, compound (PFPE) has (per)fluorocarbon end groups which do not comprise any heteroatom different from a halogen. According to these embodiments, compound (PFPE) complies with formula (I):

Y^{#}—(CFX^{#})ₘ—O(R_{f})(CFX*)ₙ—Y* (I)

wherein:
Y^{#} and Y*, equal to or different from each other, are selected from the group consisting of F, Cl, and a C₁-C₃ perfluoroalkyl group, said perfluoroalkyl group being preferably —CF₃;
m and n, equal to or different from each other, are integers equal to or higher than 1;
X^{#} and X*, equal to or different from each other, are selected from the group consisting of F and a C₁-C₃ perfluoroalkyl group, said perfluoroalkyl group being preferably —CF₃;
R_{f} is a fluoropolyoxyalkylene chain [chain (R_{f})], as above detailed.

The chain (R_{f}) is preferably a sequence comprising, more preferably consisting of, repeating units independently selected from the group consisting of:

(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, are F, Cl, H;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently F or CF₃ and T being a C₁-C₃ perfluoroalkyl group.

Preferably, chain (R_{f}) complies with the following formula:

—[(CFX¹O)_{g1}(CFX²CFX³O)_{g2}(CF₂CF₂CF₂O)_{g3}(CF₂CF₂CF₂CF₂O)_{g4}]— (R_{f}—I)

wherein
X¹ is independently selected from —F and —CF₃,
X², X³, equal or different from each other and at each occurrence, are independently —F, —CF₃, with the proviso that at least one of X is —F;
g1, g2, g3, and g4, equal or different from each other, are independently integers ≥0, such that g1+g2+g3+g4 is in the range from 2 to 300, preferably from 2 to 100; should at least two of g1, g2, g3 and g4 be different from zero.

More preferably, chain (R_{f}) is selected from chains of formula:

—[(CF₂CF₂O)ₐ₁(CF₂O)ₐ₂]— (R_{f}-IIA)

wherein:
a1 and a2 are independently integers 0 such that the number average molecular weight is between 400 and 10,000, preferably between 1,000 and 8,000; both a1 and a2 are preferably different from zero, with the ratio a1/a2 being preferably comprised between 0.1 and 10;

—[(CF₂CF₂CF₂O)_{b}]— (R_{f}-IIB)

wherein:
b is an integer >0 such that the number average molecular weight is between 400 and 10,000, preferably between 1,000 and 8,000;

—[(CF₂CF₂CF₂CF₂O)_{c}]— (R_{f}-IIC)

wherein:
c is an integer >0 such that the number average molecular weight is between 400 and 10,000, preferably between 1,000 and 8,000;

—[(CF₂CF₂O)_{d1}(CF₂O)_{d2}(CF(CF₃)O)_{d3}(CF₂CF(CF₃)O)_{d4}]— (R_{f}-IID)

wherein:
d1, d2, d3, d4, are independently integers ≥0 such that the number average molecular weight is between 400 and 10,000, preferably between 1,000 and 8,000; preferably d1 is 0, d2, d3, d4 are >0, with the ratio d4/(d2+d3) being ≥1;

—[(CF₂CF₂O)ₑ₁(CF₂O)ₑ₂(CF₂(CF₂)_{ew}CF₂O)ₑ₃]— (R_{f}-IIE)

wherein:
ew=1 or 2;
e1, e2, and e3 are independently integers ≥0 chosen so that the number average molecular weight is between 400 and 10,000, preferably between 1,000 and 8,000; preferably e1, e2 and e3 are all >0, with the ratio e3/(e1+e2) being generally lower than 0.2;

—[(CF(CF₃)CF₂O)_{f}]— (R_{f}-IIF)

wherein:
f is an integer >0 such that the number average molecular weight is between 400 and 10,000, preferably between 1,000 and 8,000.

Chains (R_{f}-IIA), (R_{f}-IIB), (R_{f}-IIC) and (R_{f}-IIE) are particularly preferred.

Still more preferably, chain (R_{f}) complies with formula (R_{f}-IIA), wherein:
a1, and a2 are integers >0 such that the number average molecular weight is between 400 and 10,000, preferably between 1,000 and 8,000, with the ratio a1/a2 being generally comprised between 0.1 and 10, more preferably between 0.2 and 5.

Capsules (M)

As said, the composition (C) comprises a plurality of capsules (M) having a cross-linked polymeric shell and a core comprising said at least one compound (PFPE), as detailed above.

Said capsules (M) have an average diameter preferably ranging from 4 μm to 8 μm, more preferably ranging from 4 μm to 6 μm.

The weight ratio between the core and the cross-linked polymeric shell of said capsules (M) preferably ranges from 20/80 to 80/20, more preferably from 30/70 to 40/60, even more preferably is 30/70.

The cross-linked polymeric shell of said capsules (M) has an average thickness preferably ranging from 0.1 μm to 1.5 μm, more preferably ranging from 0.7 μm to 1.3 μm, even more preferably ranging from 0.7 μm to 1.0 μm, most preferably ranging from 0.7 μm to 0.8 μm.

The polymeric shell of said capsules (M) is generally obtained by cross-linking at least one monomer or polymer, or a mixture of monomers or polymers, when polymerized.

By “monomer or polymer”, it should be understood any building block suitable for forming a solid material by polymerization, either alone or in combination with other monomers or polymers.

Preferably, the monomer(s) are selected from monomers bearing at least one reactive function selected from the group consisting of acrylate, methacrylate, vinyl ether, N-vinyl-ether, mercaptoester, thiolen, siloxane, epoxy, oxetan, urethane, isocyanate, and peroxide. More preferably, the monomer(s) are selected from monomers also bearing at least one function selected from the group consisting of primary, secondary and tertiary alkylamine, quaternary amine, sulphate, sulfonate, phosphate, phosphonate, hydroxyl, carboxylate, and halogen,

Preferably, said polymer(s) are selected among: polyethers, polyesters, polyurethanes, polyureas, polyethylene glycols, polypropylene glycols, polyamides, polyacetals, polyimides, polyolefins, polysulfides, and polydimethylsiloxanes, said polymers bearing at least one reactive function selected from the group consisting of acrylate; methacrylate; vinyl ether; N-vinyl ether; mercaptoester; thiolen; siloxane; epoxy; oxetan; urethane; isocyanate; and peroxide. Examples of such polymers are cited in WO 2017/046360 (CALYXIA), whose content is hereby incorporated by reference.

In a first embodiment, at least one of said monomers or polymers bears a pH-sensitive group, a temperature-sensitive group, a UV-sensitive group or a IR-sensitive group, which is able to induce the rupture of capsules (M) and the subsequent release of their content, when stimulated by a pH, a temperature, a UV or a IR external trigger, respectively. Examples thereof are described in WO 2017/046360 (CALYXIA).

In a second alternative embodiment, said polymeric shell contains nanoparticles bearing on their surface at least one reactive function selected from the group consisting of acrylate, methacrylate, vinyl ether, N-vinyl ether, mercaptoester, thiolen, siloxane, epoxy, oxetan, urethane, isocyanate, and peroxide. These nanoparticles may generate heat when stimulated by an external electromagnetic field, inducing the rupture of the microcapsule and the subsequent release of its content. Suitable nanoparticles may be selected from gold, silver, and titanium dioxide nanoparticles (which react to an IR field) and iron oxide nanoparticles (which react to a magnetic field).

Cross-Linking System

Preferably, the composition (C) comprises at least one cross-linking system, which is able to promote the curing of the elastomer (A).

According to a first embodiment, said at least one cross-linking system is a peroxide-based cross-linking system comprising at least one organic peroxide [peroxide (0)] and at least one polyunsaturated compound [compound (U)].

The choice of said peroxide (0) is not particularly critical provided that it is capable of generating radicals with the assistance of a transition metal catalyst.

Among the most commonly used peroxides, mention can be made of:
di(alkyl/aryl) peroxides, including for instance di-tert-butyl peroxide, 2,5-dimethyl-2,5-bis(tert-butylperoxy)hexane, di(t-butylperoxyisopropyl)benzene, dicumyl peroxide;
diacyl peroxides, including dibenzoyl peroxide, disuccinic acid peroxide, di(4-methylbenzoyl)peroxide, di(2,4-dichlorobenzoyl)peroxide, dilauroyl peroxide, decanoyl peroxide;
percarboxylic acids and esters, including di-tert-butyl perbenzoate, t-butylperoxy-2-ethylhexanoate, 1,1,3,3-tetramethylethylbutyl peroxy-2-ethylhexanoate, 2,5-dimethyl-2,5-di(2-ethylhexanoylperoxy)hexane;
peroxycarbonates including notably di(4-t-butylcyclohexyl)peroxydicarbonate, di(2-phenoxyethyl)peroxydicarbonate, bis[1,3-dimethyl-3-(tert-butylperoxy)butyl] carbonate, t-hexylperoxyisoproprylcarbonate, t-butylperoxyisopropylcarbonate,
perketals such as 1,1-bis(tert-butylperoxy)cyclohexane and 2, 2-bis(tertbutylperoxy)butane;
ketone peroxides such as cyclohexanone peroxide and acetyl acetone peroxide;
organic hydroperoxides such as cumene hydroperoxide, tert-butyl hydroperoxide, methylethylketone peroxide (otherwise referred to as 2-[(2-hydroperoxybutan-2-yl)peroxy]butane-2-peroxol) and pinane hydroperoxide;
oil-soluble azo initiators such as 2, 2′-azobis (4-methoxy-2. 4-dimethyl valeronitrile), 2, 2′-azobis (2.4-dimethyl valeronitrile), 2,2′-azobis(isobutyronitrile), 2, 2′-azobis(2-cyano-2-butane), dimethyl-2, 2′-azobisdimethylisobutyrate, dimethyl-2,2′-azobis(2-methylpropionate), 2,2′-azobis(2-methylbutyronitrile), 1,1′-azobis(cyclohexane-1-carbonitrile), 2, 2′-azobis[N-(2-propenyl)-2-methylpropionamide], 1-[(1-cyano-1-methyl ethyl)azo]formamide, 2, 2′-azobis(N-cyclohexyl-2-methylpropionamide), 2,2′-azobis(isobutyronitrile), 2,2′-azobis(2-cyano-2-butane), dimethyl-2,2′-azobisdimethylisobutyrate, 1,1′-azobis(cyclohexanecarbonitrile), 2-(t-butylazo)-2-cyanopropane, 2,2′-azobis[2-methyl-N-(1, 1)-bis(hydroxymethyl)-2-hydroxyethyl]propionamide, 2, 2′-azobis[2-methyl-N-hydroxyethyl]-propionamide, 2, 2′-azobis(N, N′-dimethyleneisobutyramine), 2, 2′-azobis(2-methyl-N-[1,1-bis(hydroxymethyl)-2-hydroxyethyl] propionamide), 2,2′-azobis(2-methyl-N-[1,1-bis(hydroxymethyl) ethyl] propionamide), 2, 2′-azobis[2-5 methyl-N-(2-hydroxyethyl) propionamide], 2,2′-azobis(isobutyramide) dihydrate, 2,2′-azobis(2, 2, 4-trimethylpentane), 2, 2′-azobis(2-methylpropane).

Other suitable peroxide systems are those described in patent applications EP 136596 A (MONTEDISON SPA) 10 Apr. 1985 and EP 410351 A (AUSIMONT SRL) 30 Jan. 1991, whose content is hereby incorporated by reference.

Choice of the most appropriate peroxide is done by one of ordinary skills in the art considering notably ten-hours half time temperature of the peroxide (O)

Preferably, the amount of peroxide (O) ranges from 0.1 to 15 phr, preferably from 0.2 to 12 phr, more preferably from 1.0 to 7.0 phr, relative to 100 weight parts of the elastomer (A).

The compound (U) is preferably selected among compounds comprising two carbon-carbon unsaturations, compounds comprising three carbon-carbon unsaturations and compounds comprising four or more than four carbon-carbon unsaturations.

Among compounds (U) comprising two carbon-carbon unsaturations, mention can be made of bis-olefins [bis-olefin (OF)] as above detailed, preferably selected from those complying with any of formulae (OF-1), (OF-2) and (OF-3).

Among compounds (U) comprising three carbon-carbon unsaturations, mention can be made of:
tri-substituted cyanurate compounds of general formula:

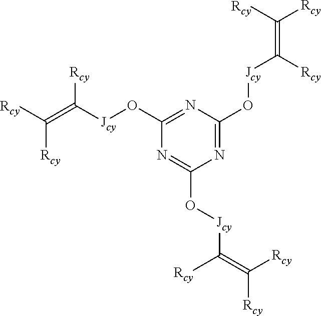

wherein each of R_{cy}, equal to or different from each other and at each occurrence, is independently selected from H or a group —R_{rcy} or —OR_{rcy}, with R_{rcy} being C₁-C₅ alkyl, possibly comprising halogen(s), and each of J_{cy}, equal to or different from each other and at each occurrence, is independently selected from a bond or a divalent hydrocarbon group, optionally comprising heteroatoms;
tri-substituted cyanurate compounds include notably preferred triallyl cyanurate, trivinyl cyanurate;
tri-substituted isocyanurate compounds of general formula:

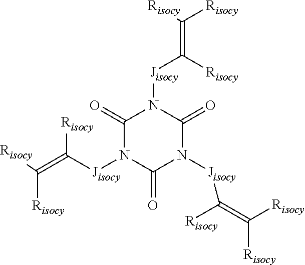

wherein each of R_{isocy}, equal to or different from each other and at each occurrence, is independently selected from H or a group —R_{risocy} or —OR_{risocy}, with R_{risocy} being C₁-C₅ alkyl, possibly comprising halogen(s), and each of J_{isocy}, equal to or different from each other and at each occurrence, is independently selected from a bond or a divalent hydrocarbon group, optionally comprising heteroatoms;
tri-substituted isocyanurate compounds include notably preferred triallyl isocyanurate (otherwise referred to as “TAIC”), trivinyl isocyanurate, with TAIC being the most preferred;
tri-substituted triazine compounds of general formula:

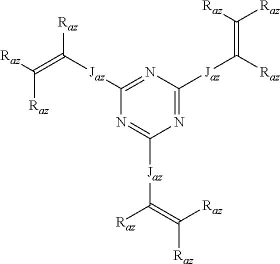

wherein each of R_{az}, equal to or different from each other and at each occurrence, is independently selected from H or a group —R_{raz} or —OR_{raz}, with R_{raz} being C₁-C₅ alkyl, possibly comprising halogen(s), and each of J_{az}, equal to or different from each other and at each occurrence, is independently selected from a bond or a divalent hydrocarbon group, optionally comprising heteroatoms; tri-substituted triazine compounds include notably compounds disclosed in EP 0860436 A (AUSIMONT SPA) 26 Aug. 1998 and in WO 97/05122 (DU PONT) 13 Feb. 1997;
tri-substituted phosphite compounds of general formula:

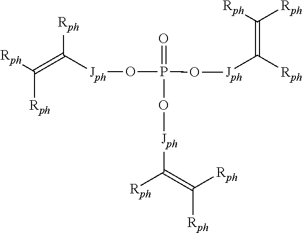

wherein each of Rₚₕ, equal to or different from each other and at each occurrence, is independently selected from H or a group —Rᵣₚₕ or —ORᵣₚₕ, with Rᵣₚₕ being C₁-C₅ alkyl, possibly comprising halogen(s), and each of Jₚₕ, equal to or different from each other and at each occurrence, is independently selected from a bond or a divalent hydrocarbon group, optionally comprising heteroatoms; tri-substituted phosphite compounds include notably preferred tri-allyl phosphite;
tri-substituted alkyltrisiloxanes of general formula:

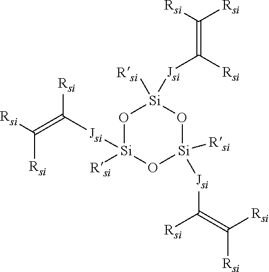

wherein each of Rₛᵢ, equal to or different from each other and at each occurrence, is independently selected from H or a group —Rᵣₛᵢ or —ORᵣₛᵢ, with Rᵣₛᵢ being C₁-C₅ alkyl, possibly comprising halogen(s), each of R′ₛᵢ, equal to or different from each other and at each occurrence, is independently selected from C₁-C₅ alkyl groups, possibly comprising halogen(s), and each of Jₛᵢ, equal to or different from each other and at each occurrence, is independently selected from a bond or a divalent hydrocarbon group, optionally comprising heteroatoms; tri-substituted alkyltrisiloxanes compounds include notably preferred 2,4,6-trivinyl methyltrisiloxane and 2,4,6-trivinyl ethyltrisiloxane;
N,N-disubstituted acrylamide compounds of general formula:

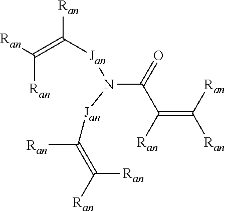

wherein each of Rₐₙ, equal to or different from each other and at each occurrence, is independently selected from H or a group —Rᵣₐₙ or —ORᵣₐₙ, with Rᵣₐₙ being C₁-C₅ alkyl, possibly comprising halogen(s), and each of Jₐₙ, equal to or different from each other and at each occurrence, is independently selected from a bond or a divalent hydrocarbon group, optionally comprising heteroatoms; N,N-disubstituted acrylamide compounds include notably preferred N,N-diallylacrylamide.

Among compounds (U) comprising four or more carbon-carbon unsaturations, mention can be made of hexa-allylphosphoramide, N,N,N′,N′-tetra-allyl terephthalamide, N,N,N′,N′-tetra-allyl malonamide and tris(diallylamine)-s-triazine of formula:

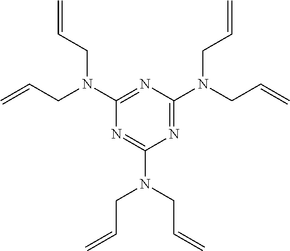 [SMILES: C=CCN(CC=C)c1nc(N(CC=C)CC=C)nc(N(CC=C)CC=C)n1]

Preferably, the compound (U) is selected from the group consisting of (i) bis-olefins (OF), in particular those of type (OF-1); and (ii) tri-substituted isocyanurate compounds, in particular TAIC.

Preferably, the amount of the compound (U) ranges from 0.1 to 20 phr, preferably from 1 to 15 phr, more preferably from 1 to 10 phr, relative to 100 weight parts of the elastomer (A).

According to a second embodiment, said at least one cross-linking system is a ionic-based cross-linking system comprising at least one polyhydroxylated compound, at least one accelerant, and at least one basic metal oxide.

Said at least one polyhydroxylated compound may be chosen among aromatic and aliphatic polyhydroxylated compounds, or derivatives thereof; examples thereof are described, notably, in EP 335705 A (MINNESOTA MINING) 4 Oct. 1989 and U.S. Pat. No. 4,233,427 (RHONE POULENC IND) 11 Nov. 1980.

The amount of the polydroxylated compound is preferably at least 0.5 phr, more preferably at least 1 phr, and preferably at most 15 phr, more preferably at most 10 phr, relative to 100 weight parts of the elastomer (A).

Said at least one accelerant is preferably selected from the group consisting of organic onium compounds, amino-phosphonium derivatives, phosphoranes, imine compounds. Examples of accelerants include: quaternary ammonium or phosphonium salts as notably described in EP 335705 A (MINNESOTA MINING) 4 Oct. 1989 and U.S. Pat. No. 3,876,654 (DUPONT) 8 Apr. 1975; aminophosphonium salts as notably described in U.S. Pat. No. 4,259,463 (MONTEDISON SPA) 31 Mar. 1981; phosphoranes as notably described in U.S. Pat. No. 3,752,787 (DUPONT) 14 Aug. 1973; imine compounds as described in EP 0120462 A (MONTEDISON SPA) 3 Oct. 1984 or as described in EP 0182299 A (ASAHI CHEMICAL) 28 May 1986.

The amount of the accelerant is preferably at least 0.05 phr, more preferably at least 0.1 phr, and preferably at most 10 phr, more preferably at most 5 phr, relative to 100 weight parts of the elastomer (A).

Said at least one basic metal oxide is preferably selected from the group consisting of divalent metal oxides including, for example, ZnO, MgO, PbO, and their mixtures, with MgO being preferred.

The amount of the basic metal oxide is preferably at least 0.5 phr, more preferably at least 1 phr, and preferably at most 25 phr, more preferably at most 15 phr, even more preferably at most 10 phr, relative to 100 weight parts of the elastomer (A).

The composition (C) according to this second embodiment optionally comprises at least one metal hydroxide, with the proviso that if said metal hydroxide is present, its amount is preferably below 6 phr, more preferably below 3 phr, based on 100 weight parts of the elastomer (A). Hydroxides which can be used are generally selected from the group consisting of Ca(OH)₂, Sr(OH)₂, Ba(OH)₂.

It is generally understood that the performances of the composition (C) according to said second embodiment can be optimized wherein the amount of metal hydroxide(s) is advantageously below 2.5 phr, preferably below 2 phr, more preferably below 1 phr, including when no metal hydroxide(s) is used, based on 100 weight parts of the elastomer (A).

According to a third embodiment, said at least one cross-linking system is a nitrile-based cross-linking system.

Whichever is the crosslinking system comprised in the composition (C), other conventional additives, such as fillers, thickeners, pigments, antioxidants, stabilizers, processing aids/plasticizers, and the like may be present. Carbon black is often used as an advantageous reinforcing system.

Should the disclosure of any of the patents, patent applications, and publications that are incorporated herein by reference conflict with the present description to the extent that it might render a term unclear, the present description shall take precedence.

Should the disclosure of any patents, patent applications and publications which are incorporated herein by reference conflict with the description of the present application to the extent that it may render a term unclear, the present description shall take precedence.

The present invention will be now described in more detail with reference to the following examples, whose purpose is merely illustrative and not limitative of the scope of the invention.

### Experimental Section

Materials

Tecnoflon® P 457 is a iodine-containing peroxide curable fluoroelastomer commercially available from Solvay Specialty Polymers Italy.

Luperox® 101XL45 is 2,5-Bis(tert-butylperoxy)-2,5-dimethylhexane commercially available from Arkema.

Drimix® TAIC 75 is 1,3,5-triallyl-1,3,5-triazine-2,4,6(1H,3H,5H)-trione commercially available from Finco.

Fomblin® YR 1800 is a perfluoropolyether commercially available from Solvay Specialty Polymers Italy.

Capsules having a polyepoxy shell, a Fomblin® YR 1800 PFPE-containing core, a core/shell weight ratio of 30/70, an average diameter of 4 μm and an average shell thickness of 0.7 μm have been produced using the methods described in WO 2017/046360 and FR 3059666.

Capsules with a polyepoxy shell and empty in the inside, having an average diameter of 4 μm and an average shell thickness of 0.7 μm have been produced using the methods described in WO 2017/046360 and FR 3059666. Said capsules are also referred to as “empty capsules”.

Methods

Molding Process

The mechanically mixed compositions of Ex.1, Ex. 2C, 3C and 4C were subjected to a molding process for 10 minutes at 160° C.

Post-Curing Process

After molding, the mechanically mixed compositions of Ex.1, Ex. 2C, 3C and 4C were subjected to a post-curing process for 4 hours at 230° C.

Rheological Measurements

Rheological measurements were carried out with MDR at 170° C. for 6 minutes.

Abrasion Test

Abrasion cycles were performed using a linear taber tester (TABER® Linear Abraser (Abrader) —Model 5750) with a weight of 1.5 kg and a pencil eraser of H-22 abradant material.

Contact Angle

The contact angle was measured according to ASTM D7334 on the pristine sample after molding and post-cure and on the same sample after 100 cycles of abrasion. Said measures were run at a temperature of 23° C.

SRV Friction Measure

The coefficient of friction (p) was measured according to ASTM G99 on the pristine sample after molding and post-cure. Said measure was run at a temperature of 50° C. with a ball made of steel 100Cr6 (German standard 100 Cr 6, near AISI L3 steel) with a diameter of 10 mm served as counterpart. The ball was heat treated to obtain a hardness of 59±1 HRC. The surface of the steel balls was grinded with an arithmetic average roughness of Ra=0.47 μm. The ball was loaded by a load of 20 N and the ball worked on material surface with a frequency of 50 Hz and a vibration length of 1 mm. The total duration of the test was 120 minutes. The coefficient of friction (μ) was measured as an average of the first 30 minutes and as an average of the last 30 minutes (from 90 minutes to 120 minutes).

Compression Set

The compression set was tested according to ASTM D395 B. Said measure was run for 70 hours at a temperature of 200° C.

Mechanical Properties Measurements

Said measurements were performed according to ASTM D412 Type C.

Preparation of Samples

### Example 1 (Ex.1)

Capsules with a Fomblin YR 1800 PFPE-containing core (5 phr) were mechanically mixed with crumbs of Tecnoflon® P 457 in an open mill together with Luperox® 101XL45 (3 phr) and Drimix® TAIC 75 (4 phr). The so obtained mechanically mixed composition was molded and post-cured.

### Example 2 of Comparison (Ex.2C)

Luperox® 101XL45 (3 phr) and Drimix® TAIC 75 (4 phr) were mechanically mixed with crumbs of Tecnoflon® P 457 in an open mill. The so obtained mechanically mixed composition was molded and post-cured.

### Example 3 of Comparison (Ex.3C)

Empty capsules (5 phr) were mechanically mixed with crumbs of Tecnoflon® P 457 in an open mill together with Luperox® 101XL45 (3 phr) and Drimix® TAIC 75 (4 phr). The so obtained mechanically mixed composition was molded and post-cured.

### Example 4 of Comparison (Ex.4C)

Fomblin® YR 1800 (1.5 phr) was mechanically mixed with crumbs of Tecnoflon® P 457 in an open mill together with Luperox® 101XL45 (3 phr) and Drimix® TAIC 75 (4 phr). The so obtained mechanically mixed composition was molded and post-cured.

Experimental Results

Table 1 shows the rheological and mechanical properties, the compression set, the contact angle and the coefficient of friction of the samples of example 1 and examples 2-4 of comparison.

TABLE 1

| | | | |
|---|---|---|---|
| Ex. 1 | Ex. 2C | Ex. 3C | Ex. 4C |

Rheological properties:

| | | | | |
|---|---|---|---|---|
| ML, lb-in | 0.3 | 0.3 | 0.3 | 0.3 |
| MH, lb-in | 15.1 | 13.9 | 16.2 | 13.5 |
| ts2, sec | 41 | 39 | 41 | 41 |
| t_02, sec | 31 | 29 | 32 | 31 |
| t_50, sec | 53 | 50 | 53 | 52 |
| t_90, sec | 75 | 71 | 77 | 73 |
| t_95, sec | 87 | 84 | 92 | 85 |

Mechanical properties:

| | | | | |
|---|---|---|---|---|
| Hardness Shore A, pts. | 57 | 55 | 58 | 52 |
| Tensile Strength, MPa | 12.0 | 14.6 | 11.7 | 13.8 |
| Elongation at break, % | 316 | 362 | 300 | 363 |
| Modulus @ 50%, MPa | 1.0 | 1.0 | 1.1 | 0.6 |
| Modulus @ 100%, MPa | 1.5 | 1.3 | 1.6 | 1.3 |

Compression set:

| | | | | |
|---|---|---|---|---|
| C-SET, % | 24 | 26 | 21 | 27 |

Contact angle vs. water:

| | | | | |
|---|---|---|---|---|
| Pristine sample, degree | 110 | 107 | 113 | 107 |
| After abrasion, degree | 149 | 127 | 125 | 138 |

SRV friction measure:

| | | | | |
|---|---|---|---|---|
| μ in the first 30 minutes | 0.42 | 0.52 | 0.57 | 0.38 |
| μ in the last 30 minutes | 0.39 | 0.47 | 0.50 | 0.45 |

The above results show that the sample of Ex.1 has a lower coefficient of friction p in the long term with respect to the samples of Ex. 2C, 3C and 4C. The above results also show that the sample of Ex.1 has a higher hydrophobicity (i.e. greater contact angle) after abrasion with no effect on curing reaction, mechanical and elastic properties.

1-20. (canceled)

21. A composition [composition (C)] comprising at least one elastomer [elastomer (A)] and a plurality of microcapsules [capsules (M)], said capsules (M) having a cross-linked polymeric shell and a core containing at least one (per)fuoropolyether compound [compound (PFPE)] comprising a (per)fluoropolyoxyalkylene chain [chain (R_{f})], said chain (R_{f}) being a sequence of recurring units having at least one catenary ether bond and at least one fluorocarbon moiety.

22. The composition (C) according to claim 21, wherein the amount of said capsules (M) ranges from 0.1 to 50 phr, based on 100 weight parts of the elastomer (A).

23. The composition (C) according to claim 21, wherein said compound (PFPE) complies with formula (I):
Y^{#}—(CFX^{#})ₘ-O(R_{f})(CFX*)ₙ—Y* (I)
wherein:
Y^{#} and Y*, equal to or different from each other, are selected from the group consisting of F, Cl, and a C₁-C₃ perfluoroalkyl group;
m and n, equal to or different from each other, are integers equal to or greater than 1;
X^{#} and X*, equal to or different from each other, are selected from the group consisting of F and a C₁-C₃ perfluoroalkyl group;
R_{f} is said chain (R_{f}).

24. The composition (C) according claim 21, wherein said chain (R_{f}) is a sequence of recurring units comprising repeating units independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, are F, Cl, H;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkylene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently F or CF₃ and T being a C₁-C₃ perfluoroalkyl group.

25. The composition (C) according to claim 21, wherein said elastomer (A) is a fluoroelastomer comprising recurring units derived from at least one (per)fluorinated monomer, wherein said (per)fluorinated monomer is selected from the group consisting of:
C₂-C₈ fluoro- and/or perfluoroolefins;
C₂-C₈ hydrogenated monofluoroolefins;
1,2-difluoroethylene, vinylidene fluoride (VDF) and trifluoroethylene (TrFE);
(per)fluoroalkylethylenes complying with formula CH₂═CH—R_{f0}, in which R_{f0} is a C₁-C₆ (per)fluoroalkyl or a C₁-C₆ (per)fluorooxyalkyl having one or more ether groups;
chloro- and/or bromo- and/or iodo-C₂-C₆ fluoroolefins;
fluoroalkylvinylethers complying with formula CF₂═CFOR_{f1} in which R_{f1} is a C₁-C₆ fluoro- or perfluoroalkyl;
hydrofluoroalkylvinylethers complying with formula CH₂═CFOR_{f1} in which R_{f1} is a C₁-C₆ fluoro- or perfluoroalkyl;
fluoro-oxyalkylvinylethers complying with formula CF₂═CFOX₀, in which X₀ is a C₁-C₁₂ oxyalkyl, or a C₁-C₁₂ (per)fluorooxyalkyl having one or more ether groups;
functional fluoro-alkylvinylethers complying with formula CF₂═CFOY₀, in which Y₀ is a C₁-C₁₂ alkyl or (per)fluoroalkyl, or a C₁-C₁₂ oxyalkyl or a C₁-C₁₂ (per)fluorooxyalkyl, said Y₀ group comprising a carboxylic or sulfonic acid group, in its acid, acid halide or salt form;
(per)fluorodioxoles, of formula: 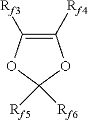
wherein each of R_{f3}, R_{f4}, R_{f5}, R_{f6}, equal to or different from each other, is independently a fluorine atom, a C₁-C₆ fluoro- or per(halo)fluoroalkyl, optionally comprising one or more oxygen atom, e.g. —CF₃, —C₂F₅, —C₃F₇, —OCF₃, —OCF₂CF₂OCF₃.

26. The composition (C) according to claim 25, wherein said elastomer (A) is selected among:
(1) VDF-based copolymers, in which VDF is copolymerized with at least one additional comonomer selected from the group consisting of:
(a) C₂-C₈ perfluoroolefins, such as tetrafluoroethylene (TFE), hexafluoropropylene (HFP);
(b) hydrogen-containing C₂-C₈ olefins;
(c) C₂-C₈ fluoroolefins comprising at least one of iodine, chlorine and bromine;
(d) (per)fluoroalkylvinylethers (PAVE) of formula CF₂═CFOR_{f}, wherein R_{f} is a C₁-C₆ (per)fluoroalkyl group;
(e) (per)fluoro-oxy-alkylvinylethers of formula CF₂═CFOX, wherein X is a C₁-C₁₂ ((per)fluoro)-oxyalkyl comprising catenary oxygen atoms;
(f) (per)fluorodioxoles having formula: 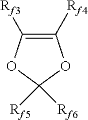
wherein each of R_{f3}, R_{f4}, R_{f5}, R_{f6}, equal to or different from each other, is independently selected from the group consisting of fluorine atom and C₁-C₆ (per)fluoroalkyl groups, optionally comprising one or more than one oxygen atom;
(g) (per)fluoro-methoxy-vinylethers (MOVE, hereinafter) having formula:
CF₂═CFOCF₂OR_{f2}
wherein R_{f2} is selected from the group consisting of C₁-C₆ (per)fluoroalkyls; C₅-C₆ cyclic (per)fluoroalkyls; and C₂-C₆ (per)fluorooxyalkyls, comprising at least one catenary oxygen atom;
(h) C₂-C₈ non-fluorinated olefins (Ol);
(i) ethylenically unsaturated compounds comprising nitrile (—CN) groups; and
(2) TFE-based copolymers, in which TFE is copolymerized with at least one additional comonomer selected from the group consisting of (c), (d), (e), (g), (h) and (i) as above detailed.

27. The composition (C) according to claim 25, wherein said elastomer (A) comprises at least one of chlorine, iodine and bromine cure sites, in an amount such that the chloride, iodine and bromine content in the elastomer is of 0.001 to 10% (wt), with respect to the total weight of the elastomer.

28. The composition (C) according to claim 21, wherein said capsules (M) have an average diameter ranging from 4 μm to 8 μm.

29. The composition (C) according to claim 21, wherein the weight ratio between the core and the cross-linked polymeric shell of said capsules (M) ranges from 20/80 to 80/20.

30. The composition (C) according to claim 21, wherein the cross-linked polymeric shell of said capsules (M) has an average thickness ranging from 0.1 μm to 1.5 μm.

31. The composition (C) according to claim 21, wherein said cross-linked polymeric shell is obtained by cross-linking at least one monomer or polymer, or a mixture of monomers or polymers, when polymerized,
said monomer(s) bearing at least one reactive function selected from the group consisting of acrylate, methacrylate, vinyl ether, N-vinyl-ether, mercaptoester, thiolen, siloxane, epoxy, oxetan, urethane, isocyanate, and peroxide,
said polymer(s) being selected among: polyethers, polyesters, polyurethanes, polyureas, polyethylene glycols, polypropylene glycols, polyamides, polyacetals, polyimides, polyolefins, polysulfides, and polydimethylsiloxanes, said polymers bearing at least one reactive function selected from the group consisting of acrylate; methacrylate; vinyl ether; N-vinyl ether; mercaptoester; thiolen; siloxane; epoxy; oxetan; urethane; isocyanate; and peroxide.

32. The composition (C) according to claim 21, further comprising a cross-linking system.

33. The composition (C) according to claim 32, wherein said at least one cross-linking system is a peroxide-based cross-linking system comprising at least one organic peroxide [peroxide (0)] and at least one polyunsaturated compound [compound (U)];
diacyl peroxides;
percarboxylic acids and esters;
peroxycarbonates;
ketone peroxides and;
oil-soluble azo initiators.

34. The composition (C) according to claim 33, wherein the amount of peroxide (O) in the composition (C) is of 0.1 to 15 phr, relative to 100 weight parts of the elastomer.

35. The composition (C) according to claim 33, wherein compound (U) is selected from the group consisting of:
compounds (U) comprising two carbon-carbon unsaturations; and
compounds (U) comprising three carbon-carbon unsaturations; and
compounds (U) comprising four or more carbon-carbon unsaturations.

36. The composition (C) according to claim 35, wherein:
the compounds (U) comprising two carbon-carbon unsaturations are selected from the group consisting of bis-olefins [bis-olefins (OF)] having general formula: 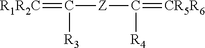
wherein R₁, R₂, R₃, R₄, R₅ and R₆, equal or different from each other, are H or C₁-C₅ alkyl; Z is a linear or branched C₁-C₁₈ (hydro)carbon radical (including alkylene or cycloalkylene radical), optionally containing oxygen atoms; and
the compounds (U) comprising three carbon-carbon unsaturations are selected from the group consisting of:
tri-substituted cyanurate compounds of general formula: 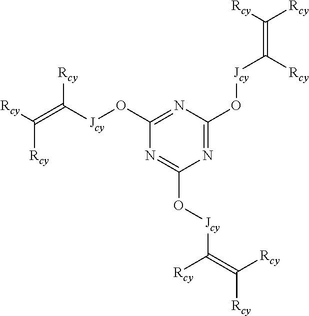
wherein each of R_{cy}, equal to or different from each other and at each occurrence, is independently selected from H or a group —R_{rcy} or —OR_{rcy}, with R_{rcy} being C₁-C₅ alkyl, possibly comprising halogen(s), and each of J_{cy}, equal to or different from each other and at each occurrence, is independently selected from a bond or a divalent hydrocarbon group, optionally comprising heteroatoms;
tri-substituted cyanurate compounds;
tri-substituted isocyanurate compounds of general formula: 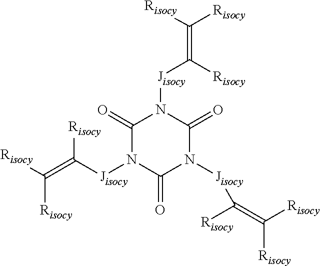
wherein each of R_{isocy}, equal to or different from each other and at each occurrence, is independently selected from H or a group —R_{risocy} or —OR_{risocy}, with R_{risocy} being C₁-C₅ alkyl, possibly comprising halogen(s), and each of J_{isocy}, equal to or different from each other and at each occurrence, is independently selected from a bond or a divalent hydrocarbon group, optionally comprising heteroatoms;
tri-substituted triazine compounds of general formula: 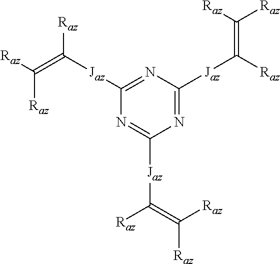
wherein each of Rₐz, equal to or different from each other and at each occurrence, is independently selected from H or a group —R_{raz} or —OR_{raz}, with R_{raz} being C₁-C₅ alkyl, possibly comprising halogen(s), and each of J_{az}, equal to or different from each other and at each occurrence, is independently selected from a bond or a divalent hydrocarbon group, optionally comprising heteroatoms;
tri-substituted phosphite compounds of general formula: 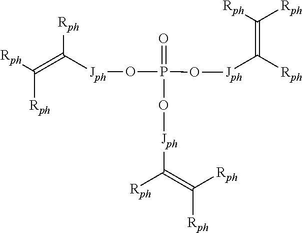
wherein each of Rₚₕ, equal to or different from each other and at each occurrence, is independently selected from H or a group —Rᵣₚₕ or —ORᵣₚₕ, with Rᵣₚₕ being C₁-C₅ alkyl, possibly comprising halogen(s), and each of Jₚh, equal to or different from each other and at each occurrence, is independently selected from a bond or a divalent hydrocarbon group, optionally comprising heteroatoms; tri-substituted phosphite compounds
include notably preferred tri-allyl phosphite;
tri-substituted alkyltrisiloxanes of general formula: 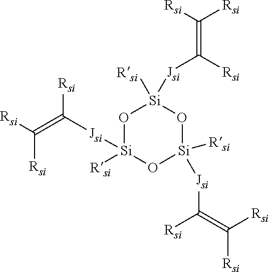
wherein each of Rₛᵢ, equal to or different from each other and at each occurrence, is independently selected from H or a group —Rᵣₛᵢ or with —ORᵣₛᵢ, being C₁-C₅ alkyl, possibly comprising halogen(s), each of R′ₛᵢ, equal to or different from each other and at each occurrence, is independently selected from C₁-C₅ alkyl groups, possibly comprising halogen(s), and each of Jₛᵢ, equal to or different from each other and at each occurrence, is independently selected from a bond or a divalent hydrocarbon group, optionally comprising heteroatoms;
N,N-disubstituted acrylamide compounds of general formula: 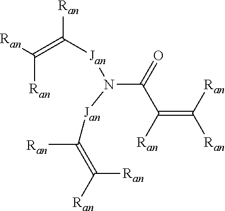
wherein each of Rₐₙ, equal to or different from each other and at each occurrence, is independently selected from H or a group —Rᵣₐₙ or —ORᵣₐₙ, with Rᵣₐₙ being C₁-C₅ alkyl, possibly comprising halogen(s), and each of Jₐn, equal to or different from each other and at each occurrence, is independently selected from a bond or a divalent hydrocarbon group, optionally comprising heteroatoms; and
the compounds (U) comprising four or more carbon-carbon unsaturations are selected from tris(diallylamine)-s-triazine of formula 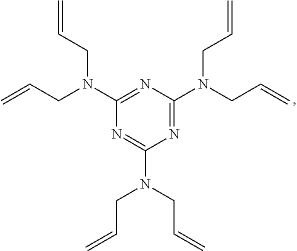 [SMILES: C=CCN(CC=C)c1nc(N(CC=C)CC=C)nc(N(CC=C)CC=C)n1]
hexa-allylphosphoramide, N,N,N′,N′-tetra-allyl terephthalamide, and N,N,N′,N′-tetra-allyl malonamide.

37. The composition (C) according to claim 33, wherein the amount of the compound (U) in the composition (C) is of 0.1 to 20 phr, relative to 100 weight parts of the elastomer.

38. The composition (C) according to claim 32, wherein said cross-linking system is a ionic-based cross-linking system comprising at least one polyhydroxylated compound, at least one accelerant, and at least one basic metal oxide.

39. Process for preparing the composition (C) according to claim 21, comprising mixing said at least one elastomer (A) with said plurality of capsules (M).

40. Method for fabricating shaped articles comprising curing the elastomer (A) contained in the composition (C) according to claim 21.

41. A shaped article by the method according to claim 40, said shaped article being a sealing article.
